(19) United States
(12) Patent Application Publication
(10) Pub. No.: US 2006/0212341 A1
(43) Pub. Date: Sep. 21, 2006

(54) System and method for profiling jurors

(76) Inventor: William D. Powers, Old Chatham, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/375,622

(22) Filed: Mar. 14, 2006

Related U.S. Application Data
(60) Provisional application No. 60/662,104, filed on Mar. 15, 2005.

(51) Int. Cl. G06F 17/30

(52) U.S. Cl. 705/10

(57) ABSTRACT

A jury profiling system and method. A profiling system is provided that includes: an attributed jury pool database for storing a set of attributed juror records; an interface for retrieving an attributed juror record from the database for a prospective juror; a system for modeling a profile of the prospective juror based on a modeling data set; and a system for generating profile data about the prospective juror based on the profile.

The present invention claims priority to co-pending U.S. Provisional Application 60/662,104, filed on Mar. 15, 2005, entitled “SYSTEM AND METHOD FOR PROFILING JURORS,” the content of which is hereby incorporated by reference.

### BACKGROUND OF THE INVENTION

1. Technical Field

The present invention relates generally to profiling individuals participating in a legal process, and more specifically relates to a system and method of profiling jurors using demographic attributes, survey data and models.

2. Related Art

In important legal cases, such as criminal prosecution and civil matters involving large sums of money, jury selection is often critical to the outcome of a trial. The process of selecting a jury, referred to as voire dire, often involves a significant amount of guesswork based on assumptions, instinct and intuition on the part of the lawyer handling the case.

To improve the chances of selecting a favorable jury, practitioners may utilize well-known jury profiling techniques. For example, a person living in an upscale neighborhood may be more likely to be pro big business, or be harder on crime. In general, the more attributes one knows about an individual (e.g., age, race, political affiliations, gender, address, income, etc.), the more accurate the profile. However, even with such attributes, jury profiling can be more of an art than a science.

Moreover, in a jury selection setting, obtaining and processing attribute information in a timely matter remains a challenge.

### SUMMARY OF THE INVENTION

The present invention addresses the above-mentioned problems, as well as others, by providing an on-line system and method for profiling jurors and others involved in a legal proceeding, and providing profiling data (e.g., a score or narrative) for those profiled. In a first aspect, the invention provides a profiling system for profiling prospective jurors, comprising: an attributed jury pool database for storing a set of attributed juror records; an interface for retrieving an attributed juror record from the database for a prospective juror; a system for modeling a profile of the prospective juror based on a modeling data set (e.g., survey data, historical data, demographic data, etc.); and a system for generating profile data about the prospective juror based on the profile.

In a second aspect, the invention provides a computer program product stored on a computer readable medium for profiling prospective jurors, comprising: program code configured for accessing an attributed jury pool database for storing a set of attributed juror records; program code configured for retrieving an attributed juror record from the database for a prospective juror; program code configured for modeling a profile of the prospective juror based on a modeling data set (e.g., survey data, historical data, demographic data, etc.); and program code configured for generating profile data about the prospective juror based on the profile.

In a third aspect, the invention provides a method for profiling prospective jurors, comprising: providing an attributed jury pool database for storing a set of attributed juror records; retrieving an attributed juror record from the database for a prospective juror; modeling a profile of the prospective juror based on a modeling data set; and generating profile data about the prospective juror based on the profile.

In a fourth aspect, the invention provides a method for deploying a juror profiling application, comprising: providing a computer infrastructure being operable to: provide access to an attributed jury pool database for storing a set of attributed juror records; retrieve an attributed juror record from the database for a prospective juror; model a profile of the prospective juror based on a modeling data set; and generate a profile score for the prospective juror based on the profile.

### BRIEF DESCRIPTION OF THE DRAWINGS

The embodiments of this invention will be described in detail, with reference to the following figures, wherein like designations denote like elements, and wherein:

FIG. 1 shows a block diagram of a real-time profiling system in accordance with the present invention.

FIG. 2 depicts a set of attributed juror records in accordance with the present invention.

FIG. 3 depicts a user interface for entering/accessing a case record in accordance with the present invention.

FIG. 4 depicts a user interface for viewing a juror pool and bias score in accordance with the present invention.

FIG. 5 depicts a user interface for entering prospective juror information in accordance with the present invention.

FIG. 6 depicts an illustrative set of profiling data generated in accordance with the present invention.

FIG. 7 depicts a historical knowledge base process in accordance with the present invention.

### DETAILED DESCRIPTION OF THE INVENTION

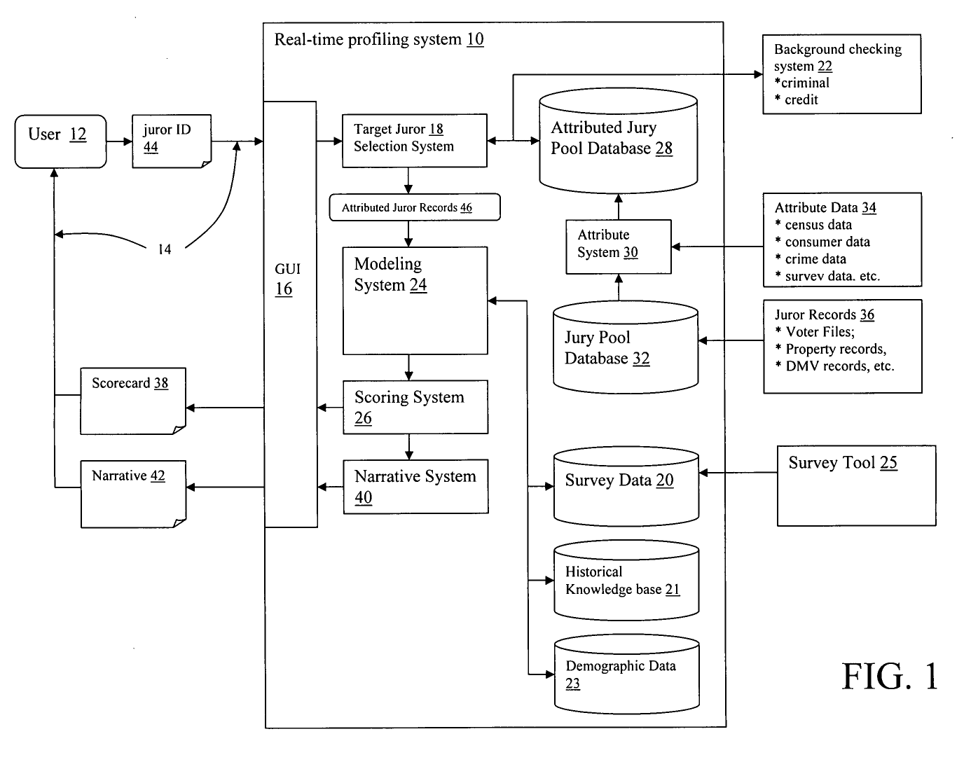

Referring now to FIG. 1, a real-time profiling system 10 is shown that allows a user 12 to obtain profile data about a prospective juror in a legal proceeding in real-time. Note that while the illustrative embodiment shown in FIG. 1 is described with reference to profiling a juror, the processes and systems described therein could be applied to profiling any individual in any setting.

In operation, user 12 (e.g., a lawyer who subscribes to the service) interfaces with real-time profiling system 10 via a graphical user interface GUI 16 over a network 14 such as the Internet via a wired or wireless connection. To obtain profile data, the user 12 first logs onto real-time profiling system 10 and is presented with GUI 16. From within GUI 16, the user 12 can then provide some type of a juror ID 44 for the prospective, or “target” juror. The juror ID 44 may for instance comprise a name and/or other relevant information, e.g., drivers license number, address, social security number, etc. Alternatively, GUI 16 may include an interface to allow the user 12 to submit an entire set or list of prospective jurors, such as a jury pool.

Once entered, target juror selection system 18 searches the attributed jury pool database 28 to find the target juror (or jurors) entered by user 12. For each target juror entered, target juror selection system 18 would return a match or list of possible matches (e.g., John Smith residing at address 1, John Smith 2 residing at address 2, etc.). In the case where a list of possible matches was returned, user 12 could then select the appropriate match.

The attributed jury pool database 28 generally comprises a list of all of the available jurors for the particular jurisdiction (e.g., county) along with a set of attributes for each juror. In this illustrative embodiment, attributed jury pool database 28 is built from a jury pool database 32 that is augmented by an attribute system 30. Jury pool database 32, which comprises a list of all of the available jurors for the particular jurisdiction, is regularly updated with juror records 36 obtained from publicly available voter files, property records, department of motor vehicle (DMV) records, etc. Thus, jury pool database 32 essentially mirrors the same records used by a court to select jurors.

Attribute system 30 appends attribute data 34 to each juror record 36 in the jury pool database 32. The attribute data 34 may include any data that describes a juror (e.g., age, political affiliations, gender, address, income, property ownership, voting record, consumer data, etc.). Attribute data 34 may be obtained from any private or publicly available source including census data, consumer data, crime data, survey data, etc. Accordingly, the resulting attributed jury pool database 28 comprises a robust set of information for each available juror in a given jurisdiction.

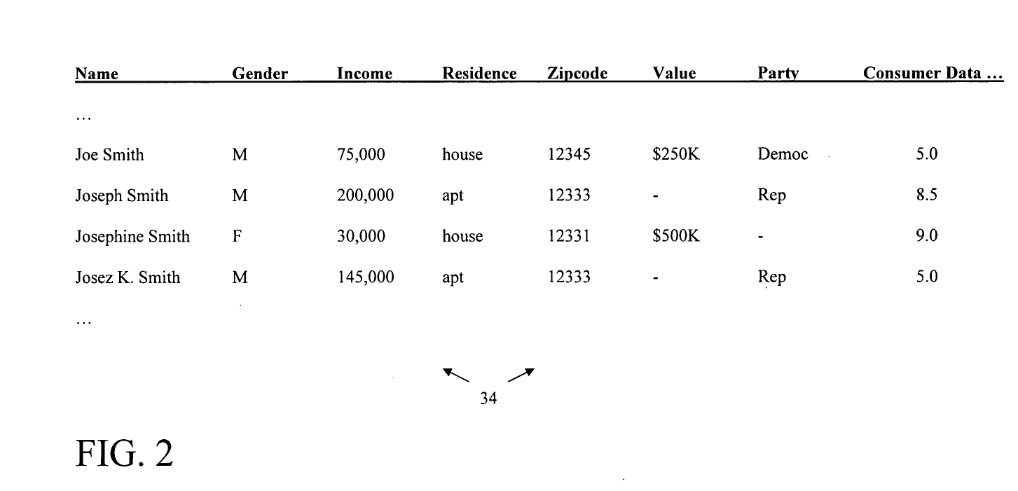

FIG. 2 depicts a simple example of a few attributed juror records that could appear in the attributed jury pool database 28. As can be seen, for each name, various attribute data 34 is also provided. Obviously, the type and amount of attribute data 34 collected can vary depending on the particular circumstances, e.g., availability, importance, etc. Moreover, it should be understood that any technique or methodology may be employed for building the attributed jury pool database 28.

Referring again to FIG. 1, once the attributed juror record 46 for a prospective juror is identified from the attributed juror pool database 28, the attributed juror record 46 is submitted to modeling system 24. Modeling system 24 may comprise any system for generating a profile of a prospective juror based on the prospective jurors attributes. For instance, fuzzy modeling may be used to identify clusters of data from a modeling data set that have similar characteristics to that of the prospective juror. Based on information gathered from such a cluster or clusters, a profile can be built by modeling system 24.

In the illustrative embodiment shown in FIG. 1, various examples of modeling data sets are shown, including survey data 20, a historical knowledge base 21, and demographic data 23, which can be utilized to create clusters into which prospective jurors may be matched. For instance, to build such a profile, modeling system 24 can matches the attributes of the attributed jury record 46 with one or more clusters of individuals in the survey data 20 or historical knowledge base 21 that have similar attributes. Once the prospective juror is matched to a cluster, modeling system 24 can examine the survey or historical data to determine biases, attributes, etc., of the cluster. Those biases, attributes, etc., can then be ascribed to the prospective juror as a profile. Additionally, modeling system 24 may consider demographic data 23 either alone or in combination with other modeling data to build a profile. It should be understood that any system for modeling biases based on survey, historical and/or demographic data could be used by modeling system 24 including, fuzzy modeling, relational fuzzy modeling, regression, statistical analysis, etc.

Survey data 20 generally includes a robust set of survey records (e.g., 20,000-30,000 records) that includes attributes, survey questions and responses of individuals who were surveyed and responded to relevant questions. Survey data 20 may be collected with a survey tool 25 that may for example be implemented via a web application. Questions provided by the survey tool 25 may include, for instance, feelings towards crime and punishment, lawyers, lawsuits, corporations, the legal system, etc. The answer to each question may be a value, e.g., between 1-5, where 5 indicates a favorable response, and 1 indicates a negative response. Thus, each survey data record may look as follows:

Name=xxxxx; attributes={A1=xx;A2=yy;A3=zz;etc}; answers={Q1=1;Q2=3;Q3=2; etc}, where A1, A2, A3 are particular attribute categories (e.g., gender, age and income) and xx, yy and zz are attribute values (e.g., male, 35, $75,000) of the person being surveyed, and Q1,Q2,Q3 are questions asked in the survey that store answers to the particular questions.

As noted, modeling system 24 attempts to match the attributes of the attributed jury record 46 with individuals in the survey data 20 that have similar attributes. For instance, an attributed juror record 46 may have attributes as follows: male, age 35, owns a house worth $150,000 in zip code 12345, married, two kids, income of $75,000, republican, etc. Modeling system 24 would identify individuals (or clusters) in survey data 20 with similar attributes. Based on matches found in survey data 20, answers to the questions given in the survey would be processed and analyzed, and a profile or model for the prospective juror is created (e.g., based on the survey data 20, a person with xyz attributes are likely to have JKL feelings, attitudes and biases towards ABC issues).

Historical knowledge base 21 comprises records of actual historical case decisions that include: case subject matter, attributes of the jurors, geography, juror profile data and the trial outcomes. For example, historical knowledge base 21 may include several cases involving a whistle blowing plaintiff suing a corporation over employment discrimination. Each case would include a list of the jurors, their attributes, how they each voted and the outcome of the case. Assuming a current case involved a similar subject matter, modeling system 24 would attempt to match the attributed juror record 46 of a prospective juror with a set or cluster of jurors from the historical knowledge base 21. A profile for the prospective juror could then be created, e.g., 4 of 5 jurors having similar attributes vote in favor of the plaintiff, tend to be anti-big business, etc.

Modeling can be done based on either or both of the survey data 20 and historical knowledge base 21, as well as demographic data 23. Moreover, separate models or profiles could be created based on each, or a single model can be created based on a synthesis of survey data 20, historical knowledge base 21 and demographic data 23. In an illustrative embodiment, historical knowledge base 21 can be built based upon results collected from subscribers/users of the real-time profiling system 10. In other words, each time a user 12 utilizes real-time profiling system 10 to profile a jury, the jury and case information about the can be collected in the historical knowledge base 21. Thus, as more and more subscribers utilize the real-time profiling system 10, and the results of each case are collected, the historical knowledge base 21 becomes more and more robust.

In addition to the information described above, historical knowledge base 21 may include any information related to each such case, including, but not limited to: the court, the judge, the attorneys involved, the plaintiff and defendant, notes, jury makeup, county, city, etc. This information can be collected via an interface provided by GUI 16.

Once a profile is modeled for the prospective juror, “profile data” can be generated and provided to the user 12. Illustrative types of profile data may include a score card 38, a narrative 42, a composite bias score, etc. In the example shown in FIG. 1, scoring system 26 may be utilized to generate a scorecard 38 that includes a set of (i.e., 1 or more) categories and scores (e.g., −5 to 5) that rate the model attitudes, feelings and biases of a prospective juror. An illustrative scorecard 38 may include the following:

| | |
|---|---|
| Likely to be pro-defendant | Score = 5 |
| Likely to be pro-plaintiff | Score = −3 |
| Likely to be pro-punishment | Score = −1 |
| Likely to return large verdict | Score = 1 |
| Likely to be sympathetic | Score = 5, etc. |

Obviously, the scorecard data presented in the scorecard 28 can vary from what is shown. In one illustrative embodiment described below, each juror is given a single “bias” score for the case, and a composite of all the jurors (seated and unseated) is calculated.

Narrative system 40 can be implemented to generate a comprehensive narrative 42 that generally describes behaviors of a demographic segment to which the prospective juror belongs. For instance, based on the attributes associated with the prospective juror, a narrative 42 may be created or selected from a set of possible narratives that paint a picture of the individual, e.g., a soccer mom who likely drives a minivan or SUV, is a member of local fitness club, subscribes to fashion magazines, orders clothing online from xyz retailers, watches xyz TV shows, etc.

In addition to the real-time profiling described above, once identified, user 12 can forward the prospective juror's name to a background checking system 22, which can perform a credit and/or criminal background check on the prospective juror. Once obtained, the background data can be forwarded back to the user 12 via GUI 16.

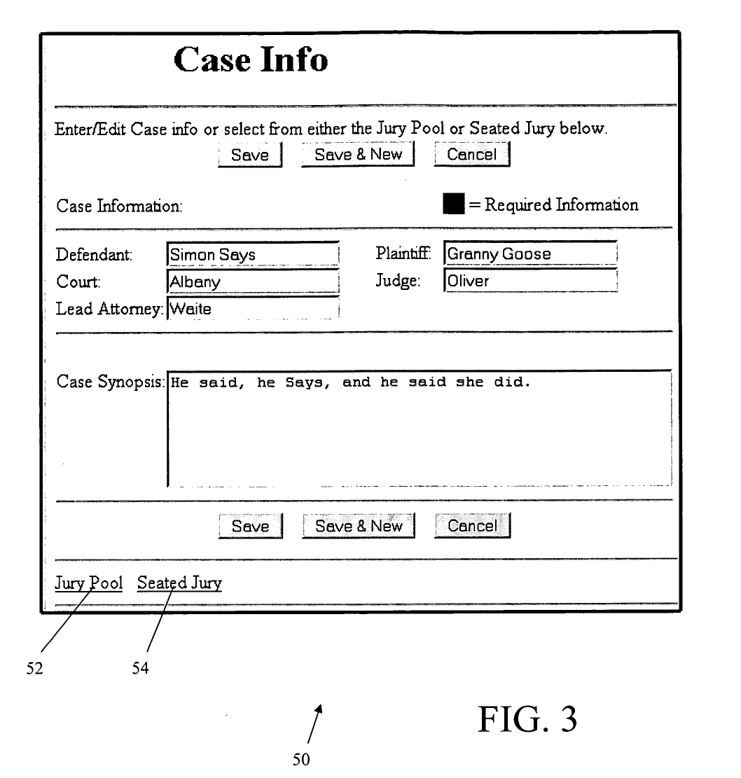

FIGS. 3-5 show illustrative interfaces that may be provided by the GUI 16. FIG. 3 depicts a case information interface 50 that could either be used to open a new case by entering information, or display an existing case. From this interface, the user 12 could examine the entire available jury pool 52 or examine the currently seated jury 54. In this case, the jury pool 52 may comprise the set of available jurors called for a given case, which in some jurisdictions is made available to the attorneys before the voire dire process.

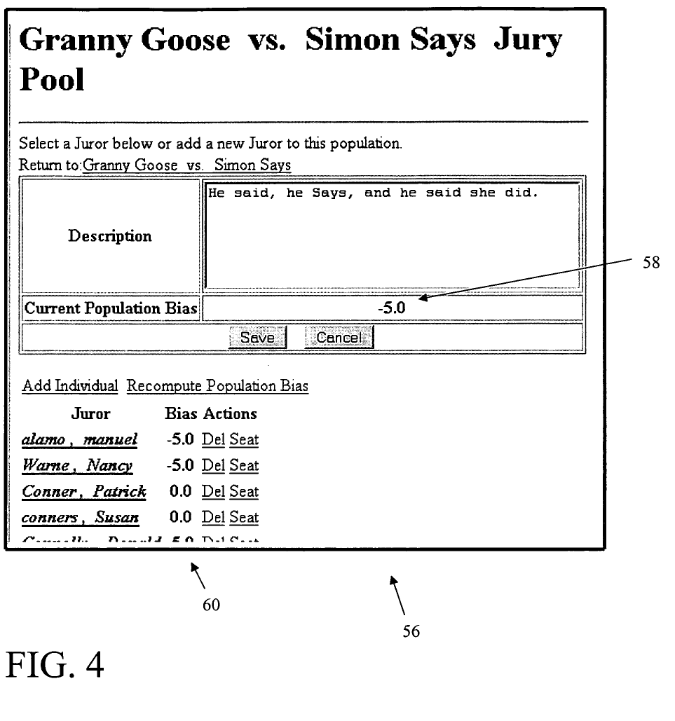

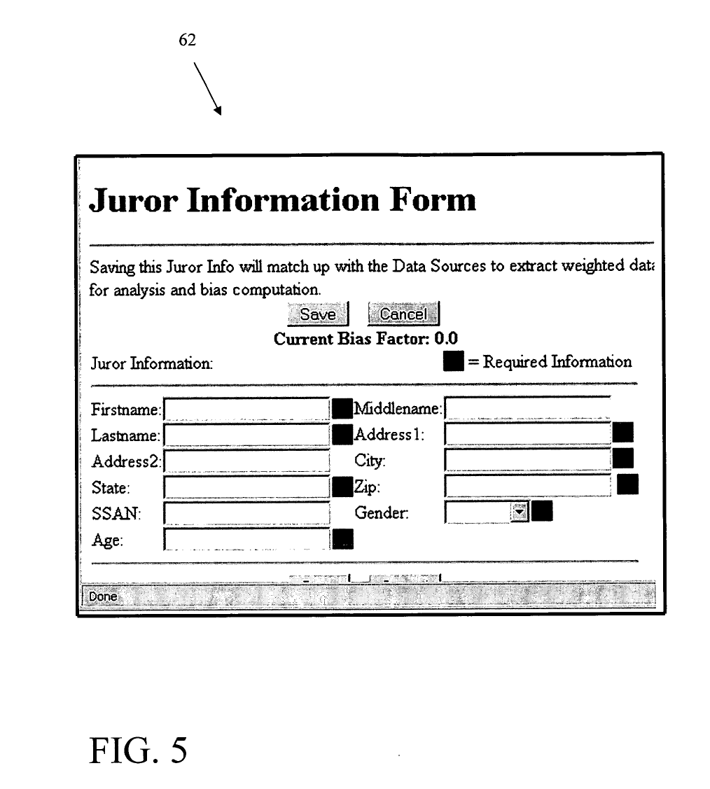

FIG. 4 depicts a jury pool interface 56 that lists each of the potential jurors in the juror pool 52. As can be seen, each juror has a “bias” 60, or score computed by the real-time profiling system 10. In addition, a current population bias 58 (e.g., −5.0) is provided, which is a composite of all of the available jurors in the jury pool 52. From this interface 56, the user 12 can delete a name from the jury pool 52, or add a name to the list of currently seated jurors. Although not shown, a similar interface for the currently seated jurors can be provided along with individual and composite biases. FIG. 5 depicts a juror information form 62, which allows the user 12 to enter a prospective juror into the real-time profiling system 10. Once entered, a bias or score for the individual can be calculated using the processes described above.

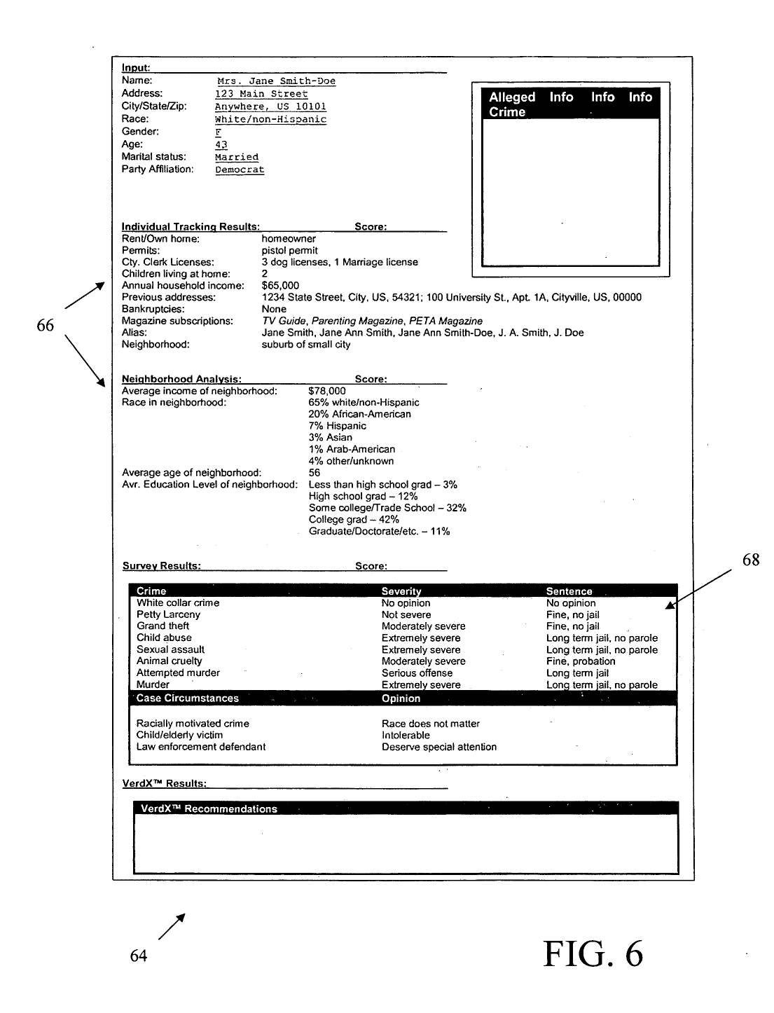

FIG. 6 depicts a more detailed profile 64 that could be generated by real-time profiling system 10. This profile 64 includes extensive demographic information (i.e., attributes) 66 about the prospective juror, as well as survey results 68 for a cluster or set of similarly matched individuals.

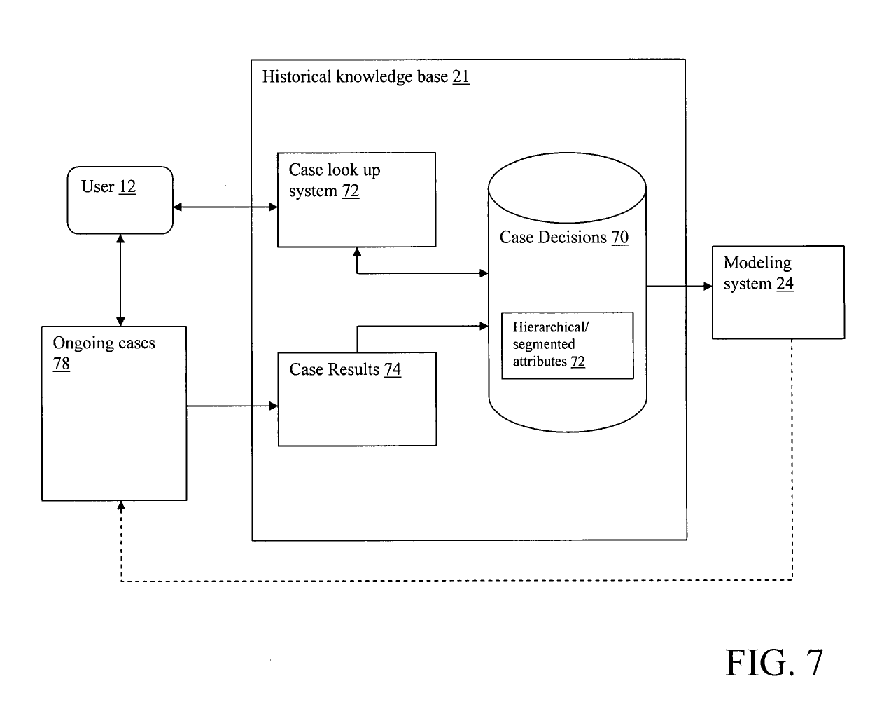

FIG. 7 depicts an illustrative system and process for implementing historical knowledge base 21 in which feedback from ongoing cases 78 is used to improve the efficacy of the process. As shown, historical knowledge base 21 includes a database of case decisions 70. Information of each decision are stored using a set of hierarchical/segmented attributes 72 that allows the user 12 to review previous cases at different levels of granularity or segmentation. For instance, case information may be categorized based on segments such as civil/criminal, charges, cause of action, defenses raised, presiding judge, lawyers, district, age of the parties, location, etc. Thus, using case lookup system 72, user 12 could search for all decisions for a particular judge involving a particular cause of action. Moreover, information, such as juror data types of crime, may be categorized based on attribute hierarchies. For instance, juror data may arranged by city, zip code, neighborhood, household, individual. Types of crime may be arranged by criminal acts, violent/non-violent, use of a fire arm, etc. Thus, using case lookup system 72, user 12 could search for all jurors in a given neighborhood that sat at a criminal trial involving gun violence.

In addition, as can be seen, because case results 74 of ongoing cases 78 are continuously provided to the database of case decisions, modeling system 24 becomes more and more robust over time to provide better modeling results for the ongoing cases.

In general, real-time profiling system 10 may be implemented on any type of computer system including as part of a client and/or a server. Such a computer system may generally include a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Additional components, such as cache memory, communication systems, system software, etc., may be incorporated into the computer system.

Access to the computer system may be provided over a network 14 such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising a real-time profiling system could be created, maintained and/or deployed by a service provider that offers the functions described herein for customers. That is, a service provider could offer to provide real-time profiling as described above. Such as service could include multi-tiered pricing based on a monthly subscription and per name look up fees.

It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A profiling system for profiling prospective jurors, comprising:
an attributed jury pool database for storing a set of attributed juror records;
an interface for retrieving an attributed juror record from the database for a prospective juror;
a system for modeling a profile of the prospective juror based on a modeling data set; and
a system for generating profile data about the prospective juror based on the profile.

2. The profiling system of claim 1, wherein the attributed jury pool data base is derived from a jury pool database that includes juror records for a jurisdiction obtained from a source selected from the group consisting of: voter files, property records and motor vehicle records.

3. The profiling system of claim 2, further comprising an attribute system that creates attributed juror records by appending attributes to juror records from jury pool database.

4. The profiling system of claim 3, wherein the attributes are obtained from a source selected from the group consisting of: census data, consumer data, crime data, and survey data.

5. The profiling system of claim 1, wherein the interface for retrieving an attributed juror record includes a form for entering a juror name.

6. The profiling system of claim 1, wherein the system for modeling a profile of the prospective juror uses fuzzy logic to cluster data from the modeling data set.

7. The profiling system of claim 1, wherein the modeling data set comprises survey data.

8. The profiling system of claim 1, wherein the modeling data set comprises a historical knowledge base.

9. The profiling system of claim 8, wherein the historical knowledge base includes case decisions having attributes that can be searched using a segmented and hierarchical approach.

10. The profiling system of claim 1, wherein the profile data comprises a bias score for the prospective juror.

11. The profiling system of claim 1, wherein the profile data comprises a narrative of the prospective juror.

12. The profiling system of claim 1, wherein the profile data is generated in real-time.

13. A computer program product stored on a computer readable medium for profiling prospective jurors, comprising:
program code configured for accessing an attributed jury pool database for storing a set of attributed juror records;
program code configured for retrieving an attributed juror record from the database for a prospective juror;
program code configured for modeling a profile of the prospective juror based on a modeling data set; and
program code configured for generating profile data about the prospective juror based on the profile.

14. The computer program product of claim 13, wherein the attributed jury pool data base is derived from a jury pool database that includes juror records for a jurisdiction obtained from a source selected from the group consisting of: voter files, property records and motor vehicle records.

15. The computer program product of claim 13, wherein the program code configured for modeling a profile of the prospective juror uses fuzzy logic to cluster data from the modeling data set.

16. The computer program product of claim 13, wherein the modeling data set comprises survey data.

17. The computer program product of claim 13, wherein the modeling data set comprises a historical knowledge base.

18. The computer program product of claim 17, wherein the historical knowledge base includes case decisions having attributes that can be searched using a segmented and hierarchical approach.

19. The computer program product of claim 13, wherein the profile data comprises a bias score for the prospective juror.

20. The computer program product of claim 13, wherein the profile data comprises a narrative of the prospective juror.

21. The computer program product of claim 13, wherein the profile data is generated in real-time.

22. A method for profiling prospective jurors, comprising:
providing an attributed jury pool database for storing a set of attributed juror records;
retrieving an attributed juror record from the database for a prospective juror;
modeling a profile of the prospective juror based on a modeling data set; and
generating profile data about the prospective juror based on the profile.

23. The method of claim 22, wherein the attributed jury pool data base is derived from a jury pool database that includes juror records for a jurisdiction obtained from a source selected from the group consisting of: voter files, property records and motor vehicle records.

24. The method of claim 22, wherein the step of modeling a profile of the prospective juror uses fuzzy logic to cluster data from the modeling data set.

25. The method of claim 22, wherein the modeling data set comprises survey data.

26. The method of claim 22, wherein the modeling data set comprises a historical knowledge base.

27. The method of claim 26, wherein the historical knowledge base includes case decisions having attributes that can be accessed using a segmented and a hierarchical approach.

28. The method of claim 22, wherein the profile data comprises a bias score for the prospective juror.

29. The method of claim 22, wherein the profile data comprises a narrative of the prospective juror.

30. The method of claim 22, wherein the profile data is generated in real-time.

31. A method for deploying a jury profiling application, comprising:
providing a computer infrastructure being operable to:
provide access to an attributed jury pool database for storing a set of attributed juror records;
retrieve an attributed juror record from the database for a prospective juror;
model a profile of the prospective juror based on a modeling data set; and
generate a profile score for the prospective juror based on the profile.
